(19) United States
(12) Patent Application Publication
(10) Pub. No.: US 2009/0064974 A1
(43) Pub. Date: Mar. 12, 2009

(54) METHOD FOR OPERATING AN INTERNAL COMBUSTION ENGINE

(75) Inventor: Andre F. CASAL KULZER, Boeblingen (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/191,705

(22) Filed: Aug. 14, 2008

(30) Foreign Application Priority Data
Sep. 6, 2007 (DE) 10 2007 042 405.3

(51) Int. Cl. F02B 33/00

(52) U.S. Cl. 123/559.1

(57) ABSTRACT

Method for the operation of an internal combustion engine, wherein the internal combustion engine comprises a combustion chamber, at least one intake valve and at least one exhaust valve, whose opening times are adjustable, wherein fresh mixture is introduced into the combustion chamber during an intake stroke; and by the introduction of fuel, an ignitable gas mixture is produced in the compression chamber and is compressed during a compression stroke and wherein the gas mixture is ignited toward the end of the compression stroke, thereby characterized, in that the fresh mixture is introduced into the combustion chamber during the intake stroke by means of a compression device and in that the intake valve is closed in such a way that the geometric compression is reduced in comparison to a closing angle, which optimal for combustion.

### TECHNICAL FIELD

The invention at hand deals with a method for operating an internal combustion engine according to the preamble of claim 1.

### BACKGROUND

With regard to an Otto (gasoline) engine the problem of knocking during combustion or pre-ignition occurs at a high load. Pre-ignition, i.e. the heat discharge before the ignition point, and knocking during combustion, i.e. the heat discharge in the final gas after the ignition point, are phenomena, which are temperature driven. Both can be brought about by secondary ignition points, as for example hot spots in the combustion chamber, for the most part on the exhaust valves, blow-by (oil mist) from the crankcase or from a spark plug with the wrong heat range as well as by a self-ignition of the mixture in the final gas prior to the flame front. Pre-ignition and knocking during combustion often limit the power output and the compression ratio of the Otto (gasoline) engine. With regard to modern Otto engines, direct gasoline injection (BDE), a variable valve drive and a supercharging, for example by a turbocharger, are state of the art. These offer the possibility to present a highly charged, conventional, homogenous, externally ignited combustion process and thereby to achieve a very highly specific power output. Also with regard to these kinds of Otto engines, the knocking during combustion is the limiting effect during full load.

### SUMMARY

A task of the invention at hand is for this reason to state a method for operating an internal combustion engine, which reduces the tendency to knock, respectively pre-ignition of the combustion.

This problem is solved by a method for operating an internal combustion engine, wherein the internal combustion engine comprises a combustion chamber, at least one intake valve and at least one exhaust valve, whose opening times are adjustable, wherein fresh mixture is introduced into the combustion chamber during an intake stroke; and by the introduction of fuel, an ignitable gas mixture is produced in the combustion chamber and is compressed during a compression stroke, wherein the gas mixture is ignited toward the end of the compression stroke, wherein the fresh mixture is introduced into the combustion chamber during the intake stroke by means of a compression device and wherein the intake valve is closed in such a way that the geometric compression is reduced in comparison to a closing angle, which is optimal for compression. The closing angle, which is optimal for compression, is a closing angle in the region of bottom dead center of the intake stroke. Normally the closing angle will slightly deviate from bottom dead center at the end of the intake stroke, for example, to utilize the momentum of the gas column, which is drawn into the combustion chamber, or to utilize the resonance effects in the intake port. Provision is made according to the invention with regard to this very slight deviation from bottom dead center to close the intake valve earlier than at the closing angle, which is optimal for compression, or later than at the closing angle, which is optimal for compression. In this instance, considerably earlier, respectively considerably later, is meant by earlier or later, so that either no optimal cylinder charge is achieved with respect to the closing angle, which is optimal for compression; or a part of the cylinder charge is again pushed out into the intake manifold using the “late intake valve closing” strategy. Provision is preferably made for the compression device to be a turbocharger or a compressor. The lambda value of the gas mixture in the compression chamber is preferably controlled in an open loop at least by the charging pressure of the compression device. The gas mixture in the combustion chamber is a mixture of fresh air, residual gas as well as injected fuel. A closed-loop control of the lambda value via the charging pressure has the advantage, in that the method is power output driven, i.e. the closed-loop control process, therefore, does not or only minimally influences the torque produced by the internal combustion engine.

The problem mentioned at the beginning of the application is also solved by a device, especially an internal combustion engine or a control unit for an internal combustion engine, which is equipped to implement a method according to the invention, as well as by a computer program with a program code for the implementation of all the steps of a method according to the invention, if the program is executed on a computer.

An example of embodiment of the invention at hand is subsequently explained in detail using the attached drawings. The following are thereby shown:

### BRIEF DESCRIPTION OF THE DRAWINGS

FIG. 1 is a sketch of a cylinder of an internal combustion engine;

FIG. 2 is a diagram of the combustion chamber pressure versus the angle of crankshaft rotation;

FIG. 3 illustrates opening and closing times of an intake valve according to the state of the art;

FIG. 4 illustrates opening and closing times of the intake valve according to a first example of embodiment of the invention;

FIG. 5 illustrates opening and closing times of the intake valve according to second example of embodiment of the invention.

### DETAILED DESCRIPTION

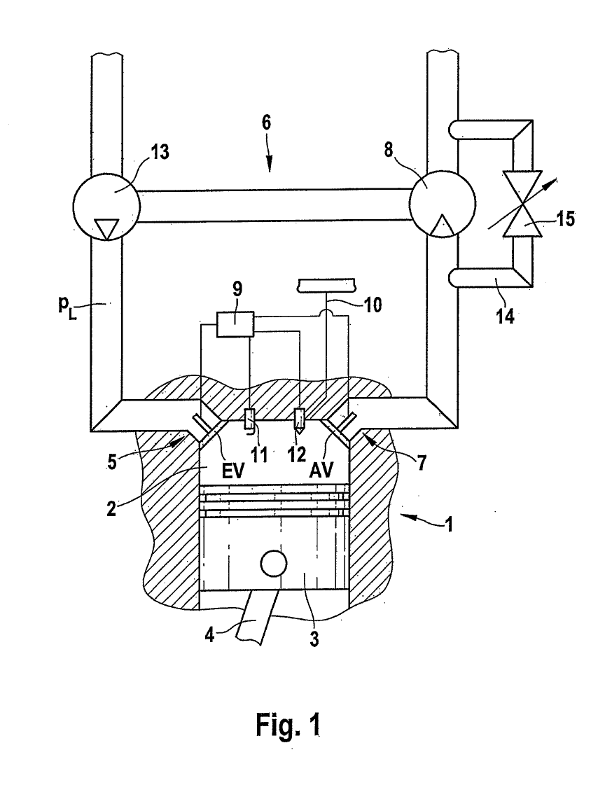

The technological environment of the invention will initially be described using FIGS. 1 to 3. In FIG. 1 a cylinder 1 of an internal combustion engine is depicted, which is otherwise not depicted in detail and which as a rule consists of several cylinders. The cylinder 1 comprises a combustion chamber 2, in which a reciprocating piston 3 with a connecting rod 4 is disposed. The connecting rod 4 is connected to an unspecified crankshaft. An inlet port 5 with an intake valve EV opens into the combustion chamber 2. Furthermore, an outlet port 7 with an exhaust valve AV opens into the combustion chamber 2. The intake valve EV as well as the exhaust valve AV is electrohydraulically activated. The internal combustion engine is therefore equipped with a so-called electrohydrualic valve control (EHVS). An electrohydraulic valve control allows for an activation of the valves, which is independent of the crankshaft position. Ambient air is drawn into the combustion chamber 2 via the inlet port 5. The exhaust gases from combustion are again discharged into the ambient environment via the outlet port 7. By means of a suitable opening time of the exhaust valve AV, for example an opening of the exhaust valve AV during the intake stroke of the internal combustion engine, a so-called internal exhaust gas recirculation can be implemented, in that exhaust gas in fact flows, respectively is drawn, out of the exhaust port 7 back into the combustion chamber 2 during the intake stroke of the cylinder 1.

A spark plug 11 as well as a fuel injector 12 opens out into the combustion chamber 2 in a known manner. The fuel injector 12 is preferably a piezoelectric injector or an electrohydraulic injector. The fuel injector 12 is connected to an unspecified high pressure rail of the internal combustion engine via a high pressure line 10. The high pressure line 10 carries fuel to the fuel injector 12. The fuel injector 12 is electrically activated by a control unit 9, and the spark plug 11 as well as the intake valve EV and the exhaust valve AV is correspondingly controlled in an open loop by the control unit 9. Instead of one intake valve EV and one exhaust valve AV, provision can also be made here for several intake valves EV and several exhaust valves AV.

With regard to electrohydraulic valve control systems without camshafts (EHVS), as they, for example, are known from the German patents DE 10127205 and DE 10134644, lift and control times of the gas exchange valves of an internal combustion engine can basically be freely programmed. The gas exchange valves are in this case the one or the several intake valve(s) EV and the one or the several exhaust valve(s) AV.

The internal combustion engine 1 additionally comprises a turbocharger 6, which is only schematically depicted in FIG. 1. The turbocharger 6 comprises in an inherently known manner a turbine 6, which actuates a supercharger 13. The charging pressure p1 in the air intake system of the internal combustion engine can be controlled in an open loop via the turbocharger rotational speed. Said speed is controlled by an adjustable bypass 14, which can shunt the exhaust gas turbine 8 and whose volumetric flow is controlled by a variable flow control valve 15. Beside a turbocharger with a bypass, other devices for the closed-loop control of the charging pressure p1 are also known, such as, for example, turbochargers with a turbine stage with variable turbine geometry, for example, a variable slope of the shovels and the like. In the example of embodiment in FIG. 1, the charging pressure p1 is controlled in an open loop by way of the position of the bypass valve 15 set by the control unit 9.

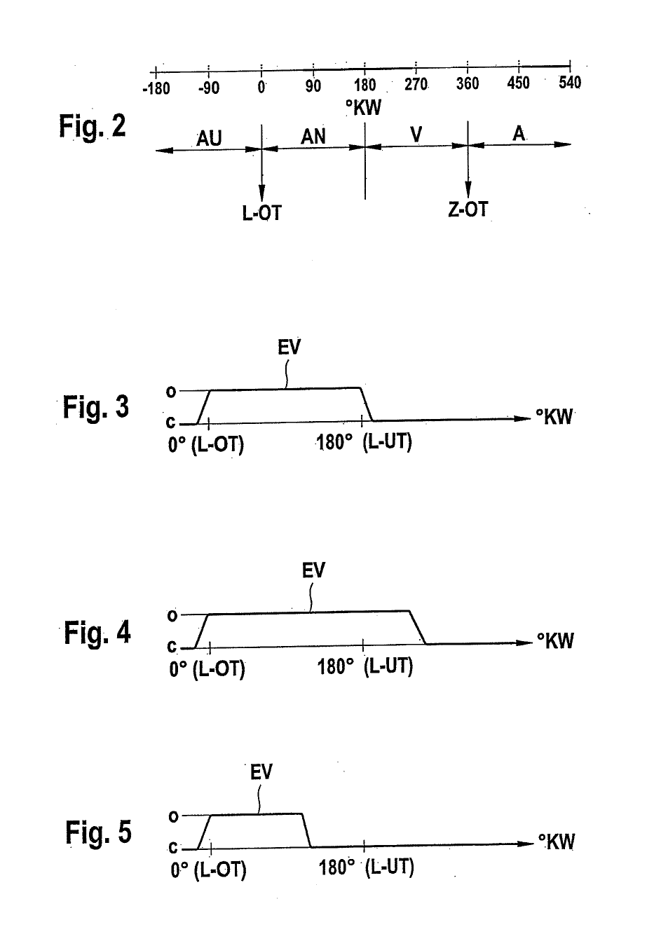

FIG. 2 shows a diagram of a power stroke of the internal combustion engine. An angle of crankshaft revolution is depicted above the ordinate in degrees of crankshaft revolution (° KW) from −180° to 540°. The combustion chamber pressure is plotted in bar above the abscissa. Top dead center in the charge transfer L-OT is selected here arbitrarily; lower top dead center of the charge cycle L-UT is achieved at 180° of crankshaft revolution KW. The charge transfer serves to discharge combusted exhaust gases in a known manner. This takes here between −180° and 0° of crankshaft revolution. Said transfer also serves to draw in fresh ambient air, respectively a fuel-air mixture. This takes place in this case in the crankshaft revolution range from 0-180°. One crankshaft revolution further, at 360° of crankshaft revolution, top dead center of the ignition (ignition TDC) Z-OT is achieved. Between 180° of crankshaft revolution and 360° of crankshaft revolution, the compression stroke V takes place. Between 360° of crankshaft revolution and 540° of crankshaft revolution, the expansion E of the combusting gases takes place. The individual strokes are denoted in FIG. 2 with the exhaust stroke AU from −180° to 0°, the compression stroke V from 180° to 360° and the expansion stroke (combustion) E from 360° to 540°. During the compression stroke V, the air mixture, respectively fuel-air mixture or fuel-air-exhaust gas mixture is compressed and in so doing heated up. The mixture is ignited as a rule shortly prior to the achievement of the ignition TDC. The ignition of the mixture leads in a known manner to an increase in pressure, which is transformed into mechanical energy in the immediately subsequent power stroke, when the expansion E of the combusting gases occurs.

FIG. 3 shows the opening and closing of the intake valve EV versus the crankshaft angle ° KW. The opening and closing behavior is depicted by a line, and the line C coinciding with 180° of crankshaft revolution thereby stands for the closed intake valve EV. A line O, which digresses from the line C, stands for the opened intake valve. By means of the inert masses, the opening and closing do not abruptly take place, so that the transitions between the opened and the closed valve, respectively vice versa, proceed ramp-shaped. FIG. 3 depicts an optimal closing of the intake valve EV. The closing of the intake valve takes place approximately at 180° of crankshaft revolution and in so doing at bottom top dead center in the charge transfer L-UT.

FIG. 4 shows a first example of embodiment of the invention at hand, wherein the intake valve EV is closed considerably later than in the process according to FIG. 3, which is optimal for combustion. The intake valve is thereby held open up into the compression stroke V, so that a back flow of intake air, respectively fuel-air mixture, into the intake manifold takes place (Atkinson cycle). In so doing, the effective compression ratio 1 is reduced. In order to compensate for the mass loss by the discharge of the mixture into the intake manifold, the supercharging pressure through the medium of the turbocharger 6 is increased, and the intake temperature of the fuel-air mixture is thereby held constant, for example by charge-air cooling. As a result, the volumetric efficiency in this example of embodiment according to the invention is approximately equal to the state of the art; however, the effective compression ratio 1 is reduced at the same time.

FIG. 5 shows a second example of embodiment of a method according to the invention, wherein in contrast to the process depicted in FIG. 3, which is optimal for combustion, respectively closing angle, which is optimal for combustion, the intake valve EV is closed before bottom dead center of the charge transfer L-UT. The intake valve EV is then closed before the intake stroke is completed (Miller cycle). Also in this instance, the effective compression ratio 1 is reduced. As was likewise the case in the previously depicted example of embodiment, the smaller effective compression ratio is compensated for by a higher supercharging pressure, so that the complete cylinder charging remains approximately constant in comparison to a process according to the state of the art. The combining of the “late intake valve closing” strategy (Atkinson cycle) according to FIG. 4, respectively of the “early intake valve closing” strategy (Miller cycle) according to FIG. 5 with a higher supercharging pressure makes a reduction of the compression ratio possible and thereby a reduction of the knock tendency. The energy requirement for the higher supercharging pressure allows itself to be compensated for by the improved degree of combustion efficiency. An improved degree of combustion efficiency and steps to avoid pre-ignition or knocking during combustion in an Otto engine with direct gasoline injection and variable valve lift provide for an optimal state of combustion, i.e. an earlier state of combustion than is the case for a late ignition timing, which is typically used to avoid knocking.

1. A method of operating an internal combustion engine, wherein the internal combustion engine includes a combustion chamber, at least one intake valve and at least one exhaust valve, wherein the at least one intake valve and the at least one exhaust valve have an adjustable opening time, and wherein a fresh mixture is introduced into the combustion chamber during an intake stroke, and by the introduction of fuel an ignitable gas mixture is produced in the compression chamber and is compressed during a compression stroke, and wherein the gas mixture is ignited toward the end of the compression stroke, the method comprising:
closing the at least one intake valve such that a geometric compression is reduced in comparison to a closing angle;
wherein the fresh mixture is introduced into the combustion chamber during the intake stroke via a compression device.

2. A method according to claim 1, further comprising closing the at least one intake valve earlier than the closing angle.

3. A method according to claim 1, further comprising closing the at least one intake valve later than the closing angle.

4. A method according to claim 1, wherein the compression device is a turbocharger.

5. A method according to claim 1, wherein the compression device is a compressor.

6. A method according to claim 1, further comprising controlling a lambda value of the gas mixture in the combustion chamber in an open loop at least by a supercharging pressure of the compression device.

7. A device, particularly an internal combustion engine or control unit for an internal combustion engine, for the implementation of a method of operating an internal combustion engine, wherein the internal combustion engine comprises a combustion chamber, at least one intake valve and at least one exhaust valve, wherein the at least one intake valve and the at least one exhaust valve have an adjustable opening time, and wherein a fresh mixture is introduced into the combustion chamber during an intake stroke, and by the introduction of fuel an ignitable gas mixture is produced in the compression chamber and is compressed during a compression stroke, and wherein the gas mixture is ignited toward the end of the compression stroke, the method comprising: closing the at least one intake valve such that a geometric compression is reduced in comparison to a closing angle; wherein the fresh mixture is introduced into the combustion chamber during the intake stroke via a compression device.

8. A computer program code that executes all the steps, if it runs on a computer, for the implementation of a method of operating an internal combustion engine, wherein the internal combustion engine comprises a combustion chamber, at least one intake valve and at least one exhaust valve, wherein the at least one intake valve and the at least one exhaust valve have an adjustable opening time, and wherein a fresh mixture is introduced into the combustion chamber during an intake stroke, and by the introduction of fuel an ignitable gas mixture is produced in the compression chamber and is compressed during a compression stroke, and wherein the gas mixture is ignited toward the end of the compression stroke, the method comprising: closing the at least one intake valve such that a geometric compression is reduced in comparison to a closing angle; wherein the fresh mixture is introduced into the combustion chamber during the intake stroke via a compression device.

9. Application of an internal combustion engine, having a compression device in an air intake system, for the implementation of a method of operating the internal combustion engine, wherein the internal combustion engine comprises a combustion chamber, at least one intake valve and at least one exhaust valve, wherein the at least one intake valve and the at least one exhaust valve have an adjustable opening time, and wherein a fresh mixture is introduced into the combustion chamber during an intake stroke, and by the introduction of fuel an ignitable gas mixture is produced in the compression chamber and is compressed during a compression stroke, and wherein the gas mixture is ignited toward the end of the compression stroke, the method comprising: closing the at least one intake valve such that a geometric compression is reduced in comparison to a closing angle; wherein the fresh mixture is introduced into the combustion chamber during the intake stroke via the compression device.
